(19) United States
(12) Patent Application Publication
(10) Pub. No.: US 2016/0189062 A1
(43) Pub. Date: Jun. 30, 2016

(54) EVENT ADMISSION TICKET UPGRADES THROUGH DISPLAYABLE CODES AT AN EVENT VENUE

(71) Applicant: STUBHUB, INC., San Francisco, CA (US)

(72) Inventors: Goran Alex Forss, San Francisco, CA (US); May Zabaneh, San Francisco, CA (US); Katie Moran, San Francisco, CA (US); Kyle Arthur Loftis, San Francisco, CA (US); Todd Studnicka, San Francisco, CA (US)

(21) Appl. No.: 14/586,764

(22) Filed: Dec. 30, 2014

(51) Int. Cl. G06Q 10/02

(52) U.S. Cl. CPC G06Q 10/02

(57) ABSTRACT

There are provided systems and method for event admission ticket upgrades through displayable codes at an event venue. A user may attend an event at a venue where the venue includes displayable codes located near seats that provide upgrades to the user's seats. An upgrade may include a change in seating information to more preferable seats, such as close seats or in a more preferable location. The upgrade may further include a benefit the user may receive if the user upgrades their seat. The user may image or scan the displayable code in order to receive the upgrade. A server offering the ticket upgrades may process available event admission ticket information to determine the upgrade to the user's current seat and present the upgrade to the user. If the user chooses to purchase the upgraded seat, media for the user may be presented at the venue on a display screen.

### TECHNICAL FIELD

The present application generally relates to event admission ticket upgrades through displayable codes at an event venue and more specifically to receiving a request to upgrade seats for an event at a venue using displayable codes at the venue.

### BACKGROUND

Users may utilize online marketplaces to purchase and sell event admission tickets to events at venues. When users purchase tickets, they may do so with a certain budget in mind. However, when the user attends the event, the user may have additional funds and be capable of purchasing more expensive tickets. Moreover, the price of tickets to an event may change, especially as the event nears or is currently happening, such that more expensive tickets fall into the budget range of users attending the event. However, without accessing the online marketplace to receive updated ticket information consistently, the user may not be aware of upgraded event admission tickets for more preferable seating. Moreover, in order to sell more expensive tickets at the venue, the event and/or venue may wish to incentivize the user with benefits and media of the user. These benefits may be communicated to the user at the time of original purchase, but if better tickets are still available as the event nears or occurs, the user may not receive benefits that may convince the user to purchase the upgraded ticket(s).

### BRIEF DESCRIPTION OF THE DRAWINGS

FIG. 1 is a block diagram of a networked system suitable for implementing the processes described herein, according to an embodiment;

FIG. 2 is an exemplary event environment having displayable codes for upgrading a user's event admission ticket, according to an embodiment;

FIG. 3 is an exemplary system environment having a communication device receiving an upgrade to an event admission ticket based on a scan of a code displayed at the event's venue, according to an embodiment;

FIG. 4 is a flowchart of an exemplary process for event admission ticket upgrades through displayable codes at an event venue, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods that provide for event admission ticket upgrades through displayable codes at an event venue. Systems suitable for practicing methods of the present disclosure are also provided.

An online ticket marketplace may offer ticket sales services to users. A user may visit the ticket marketplace and purchase one or more event admission tickets, or the user may purchase the ticket(s) through another seller (e.g., in person seller, ticket box office, etc.). The event admission ticket(s) may have seating information for one or more seats at a venue for the event. The user may then attend the event at the venue using the event admission ticket(s). While at the venue and before or during the event, the user may view one or more display signs or devices that include a code that may be entered to or otherwise captured by a communication device in possession of the user. The code may be displayed next to or with a notice that the user may enter the code into the communication device to receive an upgrade option to the user's current seat(s). For example, an upgrade may place the user in a better seat (e.g., closer and/or in a better location in the venue) using another event admission ticket. The upgrade may further include at least one of a discount to the second event admission ticket, a free or discounted food item at the venue, a free or discounted merchandise item at the venue, and a free or discounted media item associated with the user or the venue, which may incentive the user to purchase the upgrade.

The user may utilize a dedicated module with an application for the online ticket marketplace that may provide the upgrade. The user's communication device may already have the application installed, or may install the application when the user scans/images the code using a camera device of the communication device. The application and/or upgrade received by the application may be time sensitive and may delete after a set period of time from when the user scans/images the code. In other embodiments, the module and application may correspond more generally to a browser application. The code may correspond to an alphanumeric, bar, and/or QR code. Once the user scans or otherwise enters/inputs the code, a ticket upgrade request may be communicated to a server hosting the online ticket marketplace. The server may execute a ticket upgrade module having specialized hardware and/or software, which may determine the upgrade to the user's current event admission ticket(s).

The ticket upgrade module may receive the ticket upgrade request having the code and access the user's seating information for the user's current event admission ticket. Using information for available event admission tickets (e.g., tickets available in the online ticket marketplace or through the event/venue service provider), the ticket upgrade module may determine the upgrade to the user's current event admission ticket. As discussed herein, the upgrade may include another event admission ticket available at the event and for a more preferable seat. The ticket upgrade module may further determine a benefit, such as a discounted or free item, to include with the second event admission ticket in the upgrade. Once the upgrade is determined, it may be communicated to the user's communication device and displayed to the user.

The server may also provide a social networking service for use with one or more upgrades and users wishing to upgrade their event admission ticket(s). For example, the user may be alerted of at least one other user nearby the second event admission ticket offered in the upgrade. The nearby user(s) may also be user(s) who have elected to upgrade their event admission ticket(s). Additionally, the user may be given incentives to connect with the nearby user(s) using the social networking service, such as a free item at the venue. The user may also be informed of past user(s) the user has connected with and who are attending the same event as the user. Thus, when the upgrade is communicated to the user's communication device, the social networking service may be updated with the nearby and/or past users.

After the upgrade is communicated to the user's communication device, the user may elect to purchase the second event admission ticket in the upgrade to upgrade the user's seating at the venue during the event. The user may utilize the communication device to transmit a purchase request for the second event admission ticket in the upgrade. The purchase request may include a payment for an amount for the difference in price between the first (current) event admission ticket that the user possesses and the second event admission ticket in the upgrade. Once the purchase request is processed, the user may receive information for the second event admission ticket on the communication device. The information may provide the user with access to seating associated with the second event admission ticket. The ticket upgrade module may further determine a resale listing for the user's first event admission ticket so that the first event admission ticket may be resold, including as an upgrade to another user. The first event admission ticket may then be offered for resale in a listing on the ticket marketplace. Additionally, the available event admission ticket information may be updated with the information for the first event admission ticket for inclusion in further upgrades.

If the user elects to purchase the second event admission ticket in the upgrade, media for the user may be accessed and communicated to a display device (e.g., a scoreboard, television screen, big screen monitor, etc.) at the venue for display during the event. The media may be an image of the user, such as an image taken from an account with the server and/or a social networking service. The media may also be a video recording made of the user, for example, on the user's communication device, at a previous event, and/or at the current event. Additionally, a media capture device at the venue (e.g., a camera or video camera) may capture an image or video of the user approaching a seat for the second event admission ticket. The media may be presented during the event to highlight the user as a “featured user” that has purchased an upgrade to an event admission ticket.

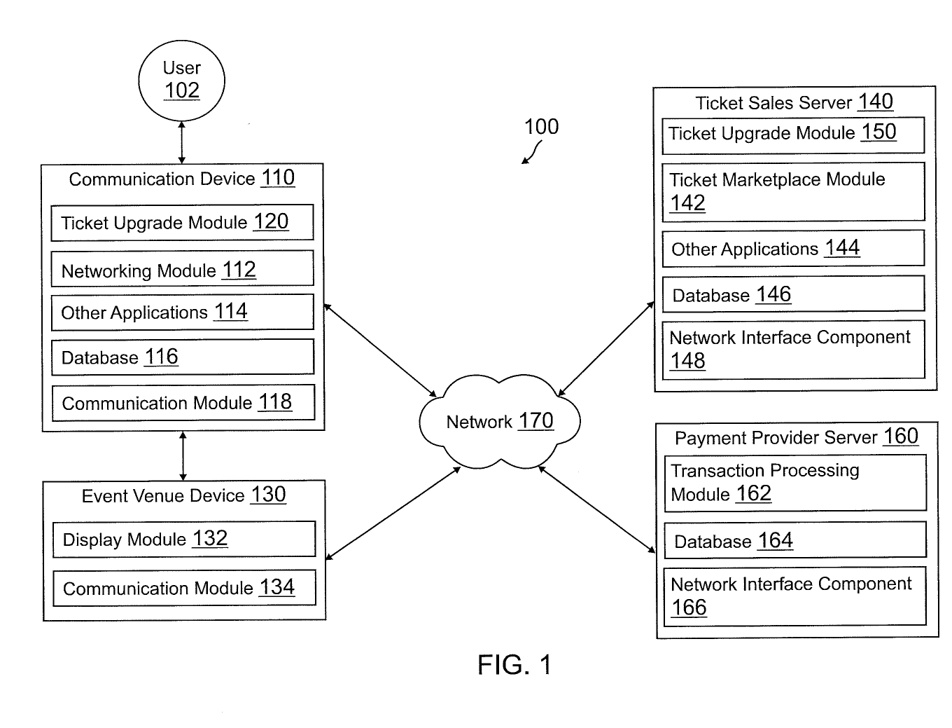

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a communication device 110, an event venue device 130, a ticket sales server 140, and a payment provider server 160 in communication over a network 170. User 102, such as an attendee to an event at a venue using a first event admission ticket, may utilize communication device 110 to capture an image of a code displayed at the event and used for ticket upgrade requests to the user's event admission ticket. User 102 may communicate the ticket upgrade request to ticket sales server 140 over network 170. Ticket sales server 140 may then determine an upgrade to present the user for a second event admission ticket at the venue and for the event. Ticket sales server 140 may communicate the upgrade to communication device 110 and may process a purchase request for the second event admission ticket using payment provider server 160. The code and/or media of user 102 may be presented during the event on event venue device 130.

Communication device 110, event venue device 130, ticket sales server 140, and payment provider server 160 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

Communication device 110 may be implemented using any appropriate hardware and software configured for wired and/or wireless communication with ticket sales server 140 and payment provider server 160. For example, in one embodiment, communication device 110 may be implemented as a personal computer (PC), a smart phone, laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a communication device is shown, the communication device may be managed or controlled by any suitable processing device. Although only one communication device is shown, a plurality of communication devices may be utilized.

Communication device 110 of FIG. 1 contains a ticket upgrade module 120, a networking module 112, other applications 114, a database 116, and a communication module 118. Ticket upgrade module 120, networking module 112, and other applications 114 may correspond to processes, procedures, and/or applications, for example, a software program, executable by a hardware processor. In other embodiments, communication device 110 may include additional or different modules having specialized hardware and/or software as required.

Ticket upgrade module 120 may correspond to one or more processes to execute modules and associated specialized hardware of communication device 110 to provide a convenient interface to permit user 102 to request and receive upgrades to event admission ticket(s) and benefits, complete a purchase request for another event admission ticket, and sell previous event admission tickets. In this regard, ticket upgrade module 120 may correspond to specialized hardware and/or software to allow user 102 to capture an image of a displayable code at a venue that may be utilized to request upgrades to event admission ticket information. Thus, ticket upgrade module 120 may provide an application to capture images using a device camera of communication device 110. Ticket upgrade module 120 may include an optical recording device of communication device 110 enabling user 102 to capture/record images, including still and/or video images. Ticket upgrade module 120 may include various features, such as zoom, flash, focus correction, shutter speed controls, or other various features usable to capture one or more images of user 102 and/or other users. Ticket upgrade module 120 may further display a preview and/or captured image to user 102 through another device of communication device 110, such as a viewfinder, screen (e.g., mobile phone screen), or other display. User 102 may utilize the digital camera or other optical receiving device to record a still image and/or video image containing the code displayed as the venue. The code may correspond to an alphanumeric, bar, and/or QR code. Thus, ticket upgrade module 120 may capture one or more visual representations of the code. In various embodiments, more than one captured image may be utilized to obtain images of multiple perspectives of the code. In other embodiments, ticket upgrade module 120 may correspond to an infrared scanner that may record the code. In some embodiments, the code may be entered by the user, such as using a keypad or the user's voice, such as when the code is a series of letters, symbols, numbers, and/or characters or is a word, phrase, or sentence.

Once the code is captured by ticket upgrade module 120, a process to transmit a ticket upgrade request to ticket sales server 140 may be initiated. Ticket upgrade module 120 may correspond to a camera module, as discussed herein, that may request data for a ticket upgrade after recording the image of the code. However, in other embodiments, ticket upgrade module 120 may correspond to a dedicated application configured to transmit a ticket upgrade request to ticket sales server 140 or may correspond more generally to a web browser configured to view information available over the Internet or access a website corresponding to a ticket upgrade service of ticket sales server 140. In certain embodiments, the application may be downloaded and installed on capture of the image of the code. The application may also be previously installed by user 102 using communication device 110. The application and/or received data may be time or location sensitive, so that the application and/or received data may be deleted if user 102 does not respond to an upgrade received from ticket sales server 140 and/or user 102 exits a specific area (e.g., an area in proximity to an event admission ticket specified in the upgrade).

The code may be displayed on a display device at the venue, such as event venue device 130 (e.g., a scoreboard, television, big screen presentation device, etc.). The code may also be displayed on a display sign, such as a billboard, placard, etc. The code may be displayed with a notification to scan/image the code to receive the upgrade. Additionally, the code may be displayed nearby the seat for the first event admission ticket currently held by user 102, near a gate or entrance to the venue nearby the first event admission ticket, at a concession stand or restroom nearby the first event admission ticket, or any other public area where the user may be able to view the upgrade offer. In various embodiments, the public area is nearby the first event admission ticket, is nearby a section containing the first event admission ticket, is along a path the user is expected to take from an entrance to the venue to the first event admission ticket (including a display at the seat corresponding to the first event admission ticket), and/or nearby the upgraded second event admission ticket. In other embodiments, the code may be displayed by seats for upgraded event admission tickets. Once the code is captured by ticket upgrade module 120, it may be transferred to ticket sales server as a ticket upgrade request for determination of an upgrade to a first event admission ticket having currently in possession of user 102 seating information for a first seat. Thus, the ticket upgrade request may be communicated to ticket sales server 140 while user 102 is attending the event at a venue (e.g., before or during the event). Further yet, the ticket upgrade request may be communicated with an identifier for user 102 used to identify user 102, a user account for user 102, and/or information for the first event admission ticket presently in possession of user 102. In other embodiments, the ticket upgrade request may be transmitted with information for the first event admission ticket (e.g., ticket information, seating information for the first seat, price, etc.) for use in determining the upgrade. Ticket sales server 140 may determine an upgrade for user 102's first event admission ticket, as discussed herein. Once ticket sales server 140 determines the upgrade, the upgrade may be communicated to communication device 110 for display to user 102 in an interface of ticket upgrade module 120.

The upgrade may include a second event admission ticket having seating information for a second seat, as well as a benefit for use with the event, venue, or second event admission ticket. The benefit may include at least one of a discount to the second event admission ticket, a free food item at the venue, a free merchandise item at the venue, and a free media item associated with the user or the venue. User 102 may view the location of the second event admission ticket on a map or interface of ticket upgrade module 120. User 102 may also view the benefit, ticket information for the second event admission ticket, price of the second event admission ticket, and price difference between the first event admission ticket and the second event admission ticket. User 102 may utilize ticket upgrade module 120 to complete a purchase request for the second event admission ticket, such as by transmitting the purchase request to ticket sales server 140 for processing. The purchase request may include authorization to purchase the second event admission ticket. Payment for the second event admission ticket may correspond to payment for the entire price of the second event admission ticket or payment for a price different between the first event admission ticket and the second event admission ticket. Payment may be complete through a payment instrument transmitted with the purchase request. A payment instrument may correspond to a payment card (e.g., a credit/debit card), a bank account, and/or a payment account with payment provider server 160.

Ticket upgrade module 120 may also be utilized to provide media of user 102 to event venue device 130 and/or ticket sales server 140 for presentation after user 102 purchases the second event admission ticket in the upgrade. For example, the media may correspond to an image of video of user 102 captured by communication device 110 or accessible through another application of communication device 110 (e.g., a social networking application of other applications 114). In other embodiments, the media may be accessible by ticket sales server 140 using an identifier provided for user 102 by ticket upgrade module 120, such as a social networking account identifier. Additionally, further embodiments may feature a media capture device at the venue configured to capture an image/video of user 102 as user 102 approaches the second seat for the second event admission ticket. Thus, the media provided to event venue device 130 may feature media captured at the venue.

If user 102 purchases the second event admission ticket in the upgrade, ticket upgrade module 120 may be utilized to resell the first event admission ticket. Ticket sales server 140 may determine a resale listing for the first event admission ticket that may include an offer for resale of the first event admission ticket to another user. Ticket upgrade module 120 may present the resale listing to user 102 for approval. User 102 may utilize ticket upgrade module 120 to edit the resale listing and approve the resale listing for posting in a ticket marketplace. Additionally, ticket upgrade module 120 may be used to notify user 102 of sale of the first event admission ticket and account services for receipt of payment for the first event admission ticket. In another embodiment, ticket upgrade module 120 may offer user 102 a price to purchase the first event admission ticket if the user purchases the second event admission ticket. If the user 102 accepts, the price for the second event admission ticket may be reduced by the price offered for the first admission ticket, along with any service fees as applicable. In another embodiment, the price for the second event admission ticket may be presented as surrender of the first event admission ticket plus an additional amount (e.g., the price offset by a value associated with the first event admission ticket). The price or value of the first event admission ticket may be determined in a variety of ways, including the value the user paid, the current value based on auction data, the value of the upgraded ticket, etc. In this way, the user 102 does not have to worry about being stuck with the first event admission ticket if it cannot be resold during the event.

Networking module 112 may correspond to one or more processes to execute modules and associated specialized hardware of communication device 110 to provide a convenient interface to permit user 102 to perform social networking with one or more nearby users to a seat in an event admission ticket offered to user 102 through an upgrade determined by ticket sales server 140. In this regard, networking module 112 may correspond to specialized hardware and/or software that may provide a social networking service to user 102 that may connect user 102 with one or more other users. User 102 may search and locate other users on the social network provided by networking module 112 using networking module 112 and add the other users to a friend's list or other social network for user 102. Additionally, when user 102 is presented an upgrade to user 102's current event admission ticket through ticket upgrade module 120, networking module 112 may further display one or more nearby users seated in seats nearby the seat for the event admission ticket in the upgrade and utilizing the social network. The nearby users may include users who also have upgraded their event admission tickets. User 102 may be provided with an incentive to connect and/or interact with the nearby users, such as a free item or discount if the user connects with the nearby users and/or visits a store/concession stand with the nearby users. Networking module 112 may further display past users that user 102 has connected with at past events, including whether the user is present at the current event, and where the user is seated at the current event.

In various embodiments, one or more features of networking module 112 and ticket upgrade module 120 may be incorporated in the same module so as to provide their respective features in one module.

Communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 170, or other types of applications. Other applications 114 may also include email, texting, voice and IM applications that allow a user to send and receive emails, calls, texts, and other notifications through network 170. In various embodiments, other applications 114 may include financial applications, such as banking, online payments, money transfer, or other applications associated with payment provider server 160. Where such features are not provided by networking module 112 and/or ticket upgrade module 120, other applications may include browser applications, payment applications, and/or image/video archiving application. Other applications 114 may contain software programs, executable by a processor, including a graphical user interface (GUI) configured to provide an interface to the user.

Communication device 110 may further include database 116 which may include, for example, identifiers such as operating system registry entries, cookies associated with ticket upgrade module 120, networking module 112, and/or other applications 114, identifiers associated with hardware of communication device 110, or other appropriate identifiers, such as identifiers used for payment/user/device authentication or identification. Database 116 may include images captured by networking module 112, including images of a code displayed at a venue for a ticket upgrade. Database 116 may be accessed by networking module 112, ticket upgrade module 120, and/or ticket sales server 140 to store, transmit, and/or receive images. In one embodiment, identifiers in database 116 may be used by a payment/credit provider, such as payment provider server 160, to associate communication device 110 with a particular account maintained by the payment/credit provider. Database 116 may further include payment card information, including credit, debit, and/or gift card information. In various embodiments, database 116 may include online account access information. Database 116 may further store current event admission ticket information, upgrades to a current event admission ticket, purchased event admission ticket information for an event admission ticket in the upgrade, benefits received with the event admission ticket, and/or resale listings for previous event admission tickets. Database 116 may also store social media, networking information, and contacts of user 102.

Communication device 110 includes at least one communication module 118 adapted to communicate with ticket sales server 140 and payment provider server 160 over network 170. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Event venue device 130 may be implemented using any appropriate hardware and software configured for wired and/or wireless communication with communication device 110 and ticket sales server 140 for use during an event for displaying a code and/or presenting media of user 102 if user 102 chooses to purchase an event admission ticket in an upgrade. For example, in one embodiment, event venue device 130 may be implemented as a television, projector display, scoreboard, or other event venue device. Although only one event venue device is shown, a plurality of event venue devices may be utilized

Event venue device 130 of FIG. 1 contains a display module 132 and a communication module 134. Display module 132 may correspond to processes, procedures, and/or applications, for example, a software program, executable by a hardware processor. In other embodiments, event venue device 130 may include additional or different modules having specialized hardware and/or software as required.

Display module 132 may correspond to one or more processes to execute modules and associated specialized hardware of event venue device 130 to display information during an event. In this regard, display module 132 may correspond to specialized hardware and/or software of event venue device 130 to receive information that may be displayed during an event using communication module 134 and/or through an input device of event venue device 130. Such displayable information may include sport scores, lighting and live camera feeds for a concert, background displays for a theater production, and/or other types of displayable information. Display module 132 may further be utilized to display a code for use in providing an upgrade to a user's event admission ticket seating. The code may be displayed with a notification informing the user to scan the code to receive the upgrade. However, in other embodiments, the code may be displayed on a billboard, placard, or other display sign at the venue. The code may be location specific, so that the code corresponds to upgraded event admission tickets for seats in proximity to the code. Display module 132 may also display received media of user 102 after user 102 purchases an event admission ticket in a received upgrade, for example, an image or video of user 102 approaching the seat for the upgraded event admission ticket.

Event venue device 130 includes at least one communication module 134 adapted to communicate with communication device 110 and ticket sales server 140 over network 170. In various embodiments, communication module 134 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Ticket sales server 140 may be maintained, for example, by an online ticket sales and delivery provider, which may provide event admission ticketing services and/or processing for event admission tickets sold by private sellers, venues, and multi-venue sellers. In this regard, ticket sales server 140 includes one or more processing applications which may be configured to interact with communication device 110, event venue device 130, and/or payment provider server 160 to facilitate creation of sale offers for event admissions tickets and payment for the event admission tickets. In one example, the ticket sales server may be provided by STUBHUB®, Inc. of San Francisco, Calif., USA. However, in other embodiments, the ticket sales server may be maintained by or include a credit provider, payment provider, and/or other service provider, which may provide ticketing services to user 102.

Ticket sales server 140 of FIG. 1 includes a ticket upgrade module 150, a ticket marketplace module 142, other applications 144, a database 146, and a network interface component 148. Ticket upgrade module 150, ticket marketplace module 142, and other applications 144 may correspond to processes, procedures, and/or applications, for example, a software program, executable by a hardware processor. In other embodiments, ticket sales server 140 may include additional or different modules having specialized hardware and/or software as required.

Ticket upgrade module 150 may correspond to one or more processes to execute modules and associated specialized hardware of ticket sales server 140 to receive a ticket upgrade request from communication device 110, determine an upgrade to user 102's event admission ticket(s) having an upgraded event admission ticket, communicate the upgrade to communication device 110, and/or process a sale for the upgraded event admission ticket in the upgrade. In this regard, ticket upgrade module 150 may correspond to specialized hardware and/or software that may process a ticket upgrade request received from communication device 110 and having an image or scan of a code for an upgrade to a current event admission ticket of user 102 and displayed at a venue. For example, ticket upgrade module 150 may receive the ticket upgrade request from communication device 110. Ticket upgrade module 150 may also access an API of ticket sale application 112 to retrieve the image/scan. In other embodiments, ticket upgrade module 150 may receive the image/scan from another image storage device, such as an online image storage server. Ticket upgrade module 150 may then verify the code in the ticket upgrade request and determine an upgrade to user 102's first (current) event admission ticket using information for the first event admission ticket. The information for the first event admission ticket may include first seating information for a first seat for the event at the venue. Ticket upgrade module 150 may receive the information for the first event admission ticket from communication device 110 in the ticket upgrade request. However, in other embodiments, ticket upgrade module 150 may access the information from database 146, such as in a user account for user 102.

Ticket upgrade module 150 may further access available event admission ticket information for available event admission tickets for the event at the venue. The available event admission ticket information may correspond to all available event admission tickets in any part of the venue for the event. In other embodiments, the available event admission ticket information may be location specific, such as a for event admission tickets available for purchase in proximity to the code used by user 102 in the ticket upgrade request. The available event admission ticket information may be utilized with user 102's first (current) event admission ticket to determine and upgrade to user 102's first event admission ticket, such as a second event admission ticket for a better seat, row, area, location, visibility, or other ticket parameter. The second event admission ticket may be more expensive than user 102's first event admission ticket, or may be the same or similar price. The second event admission ticket may also constitute an upgrade by being located nearby friends or other contact from networking module 112. Ticket upgrade module 150 may further determine a benefit for inclusion with the second event admission ticket, which may incentivize the user to purchase the second event admission ticket in the upgrade. The benefit may be given to user 102 if user 102 purchases the second event admission ticket. The benefit may include at least one of a discount to the second event admission ticket, a free food item at the venue, a free merchandise item at the venue, and a free media item associated with the user or the venue.

If user 102 selects to purchase the second event admission ticket in the upgrade, ticket upgrade module 150 may receive a purchase request from communication device 110, as discussed herein. Ticket upgrade module 150 may process the purchase request using a payment instrument in the purchase request. In various embodiments, payment provider server 160 may be utilized to complete payment for the purchase request. The purchase request may be for the full value of the second event admission ticket. However, in other embodiments, the purchase request may be for a price difference between the first event admission ticket and the second event admission ticket. Where the second event admission ticket is more expensive, then user 102 may provide payment for the price difference. However, if the second event admission ticket is less expensive, an account for user 102 may be credited with the difference. Once payment is complete for the second event admission ticket, the second event admission ticket and/or information for utilizing the second event admission ticket may be communicated to communication device 110. For example, user 102 may receive an image, scan, email, code, or other information (e.g., displayable information) that provides access the seat associated with the second event admission ticket.

Where ticket upgrade module 150 provides for payment of the difference between the two event admission tickets, ticket upgrade module 150 may take ownership of the first event admission ticket and resell the first event admission ticket on the terms of ticket upgrade module 150 using ticket marketplace module 142. Thus, ticket upgrade module 150 may determine a resale listing having an offer for sale of the first event admission ticket to post on a ticket marketplace of ticket marketplace module 142. However, if user 102 retains ownership of the first event admission ticket, ticket upgrade module 150 may determine the resale listing and transmit the resale listing to communication device 110 for display to user 102. User 102 may then edit, decline, or approve the resale listing and have the resale listing posted to the ticket marketplace. Further, ticket upgrade module 150 may update the available event admission ticket information in database 146 for use in presenting event admission ticket upgrades to one or more other users that may scan a code at the venue.

As discussed herein, ticket upgrade module 150 may access, request, and/or retrieve media of user 102 after user 102 purchases the second event admission ticket in the upgrade. The media may be communicated to event venue device 130 for display during the event. The media may also be captured of user 102 while user 102 is at the venue by a media recording/capture device (e.g., a camera or video camera). Such media may be directly output by event venue device 130 without use of ticket sales server 140.

Ticket upgrade module 150 may also provide social networking services to user 102 for connecting with one or more nearby users to an event admission ticket, such as the first event admission ticket and/or the second event admission ticket. Thus, ticket upgrade module 150 may determine users in proximity to the event admission ticket and display the nearby users in an interface of networking module 112, for example, with an option to connect with the users. User 102 may be incentivized to connect with the nearby users by providing a benefit for connecting with the users, such as a discount, free item, rebate, credit, etc., for use at the venue. The benefit may be provided to user 102 when user 102 utilizing networking module 112 to connect with the nearby user(s). In other embodiments, user 102 may be required to visit a sales location (e.g., a merchandise store, concession stand, etc.) with the other nearby user(s) in order to receive the benefit.

Ticket marketplace module 142 may correspond to one or more processes to execute modules and associated specialized hardware of ticket sales server 140 to provide an online marketplace enabling user, including user 102, to post listings having sale offers for event admission tickets, view the listings, and complete transactions to pay for the event admission tickets in the listings to receive the event admission ticket(s). In this regard, ticket marketplace module 140 may correspond to specialized hardware and/or software to provide a marketplace interface displayable on communication device 110. In various embodiments, ticket marketplace module 142 may correspond to a marketplace where a plurality of users and/or venues may sell event admission tickets. Thus, ticket marketplace module 142 may offer services similar to STUBHUB®, Inc. of San Jose, Calif., USA, and/or EBAY®, Inc. of San Jose, Calif., USA. However, marketplace application 122 may correspond more generally to any application enabling ticket sales server 140 to offer event admission tickets for sale to users. Event admission tickets available from ticket marketplace module 142 may correspond to a venue, event, location, etc.

Ticket marketplace module 142 may include event admission tickets for sale, purchase prices of the event admission tickets, inventory of the event admission tickets, and/or terms of purchase. Ticket marketplace module 142 may further track information about sales and prices of event admission tickets. For example, ticket marketplace module 142 may adjust and/or track sale prices and inventory levels as purchases are made. In addition to being accessible directly by communication device 110, ticket marketplace module 142 may be utilized by payment provider server 160 (through accessing an API of ticket marketplace module 142), to complete payment for an event admission ticket, transmission of payment, and/or delivery of the event admission tickets to user 102. For example, ticket marketplace module 142 may also be configured to interact with payment provider server 160 to complete purchase requests corresponding to sale offers for event admission tickets available with ticket marketplace module 142.

In various embodiments, ticket sales server 140 includes other applications 144 as may be desired in particular embodiments to provide features to ticket sales server 140. For example, other applications 144 may include security applications for implementing server-side security features, programmatic server applications for interfacing with appropriate application programming interfaces (APIs) over network 170, or other types of applications. Other applications 144 may contain software programs, executable by a processor, including a graphical user interface (GUI), configured to provide an interface to a user.

Additionally, payment provider server 140 may include database 146. User 102 may establish one or more user accounts with ticket sales server 140 in order to sell and/or purchase event admission tickets. Database 146 may include user accounts having user information, such as name, address, birthdate, payment/funding information, additional user financial information, and/or other desired user data. User 102 may link to a user account in database 146 through a user identifier and/or communication device identifier. However, in other embodiments, user 102 may not have previously established a user account. Thus, ticket sales server 140 may list ticket sales listings/postings and complete a transaction based on another user identifier/account received from communication device 110 and/or payment provider server 160. Additionally, database 146 may include available event admission ticket information for use in determining an upgrade to user 102's first event admission ticket. Received information may be stored to database 146, such as ticket upgrade requests, information for a first event admission ticket, purchase requests and payment instruments, and/or media of user 102. Database 146 may store other information communicated to communication device 110, such as an upgrade to the first event admission ticket having a second event admission ticket.

In various embodiments, ticket sales server 140 includes at least one network interface component (NIC) 148 adapted to communicate with network 170 including communication device 110 and/or payment provider server 160. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Payment provider server 160 may be maintained, for example, by an online payment service provider, which may provide payment services and/or processing for financial transactions on behalf of a user with a ticket sales service, such as ticket sales server 140. In this regard, payment provider server 160 includes one or more processing applications which may be configured to interact with communication device 110 and/or ticket sales server 140 to facilitate payment for a transaction (e.g., a sale offer for an event admission ticket). In one example, payment provider server 160 may be provided by PAYPAL®, Inc. of San Jose, Calif., USA. However, in other embodiments, payment provider server 160 may be maintained by or include a credit provider, financial services provider, financial data provider, and/or other service provider, which may provide payment services to user 102.

Payment provider server 160 of FIG. 1 includes a transaction processing module 162, database 164, and a network interface component 166. Transaction processing module 162 may correspond to processes, procedures, and/or applications executable by a hardware processor, for example, a software program. In other embodiments, payment provider server 160 may include additional or different software as required.

Transaction processing module 162 may correspond to one or more processes to execute modules and associated specialized hardware of payment provider server 160 to receive and/or transmit information from communication device 110 and/or ticket sales server 140 for processing and completion of financial transactions for event admission tickets. In this regard, transaction processing module 162 may correspond to specialized hardware and/or software to process financial transaction information from communication device 110 and ticket sales server 140 by receiving a payment token from ticket sales server 140 for payment of sale offer for an event admission ticket. The payment token may correspond to a payment request from a user (including, in various embodiments, user 102) to ticket sales server 140. The payment token may be encrypted prior to transmission to transaction processing application 132. The payment token may include information corresponding to user identifiers, user financial information/identifiers, transaction information and/or identifiers, and/or ticket sales server 140 identifiers. Additionally, the payment token may include a payment request having payment amount and terms of payment for the sale offer. Once received, transaction processing module 162 may utilize a payment account or financial information of the paying user to render payment for the sale offer. Payment may be made to ticket sales server 140 and/or a payment/financial account corresponding to the selling user, for example, ticket sales server 140, a merchant, event/venue administrator, or third party ticket salesperson. Additionally, transaction processing module 162 may provide transaction histories, including receipts, to communication device 110 and/or ticket sales server 140 for completion and documentation of the financial transaction for the sale offer.

Additionally, payment provider server 140 includes database 164. As previously discussed, user 102 may establish one or more user accounts with payment provider server 160. Database 164 may include user accounts having user information, such as name, address, birthdate, payment/funding information, additional user financial information, and/or other desired user data. User 102 may link a user account in database 164 to communication device 110 through a user identifier, communication device identifier, and/or user account identifier. Thus, when an appropriate identifier is transmitted to payment provider server 140, e.g. from communication device 110 and/or ticket sales server 140, a user account belonging to user 102 may be found. However, in other embodiments, user 102 may not have previously established a user account. Thus, payment provider server 160 may complete a transaction based on other user financial information received from communication device 110 and/or ticket sales server 140.

In various embodiments, payment provider server 160 includes at least one network interface component (NIC) 166 adapted to communicate with network 170 including communication device 110 and/or ticket sales server 140. In various embodiments, network interface component 166 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

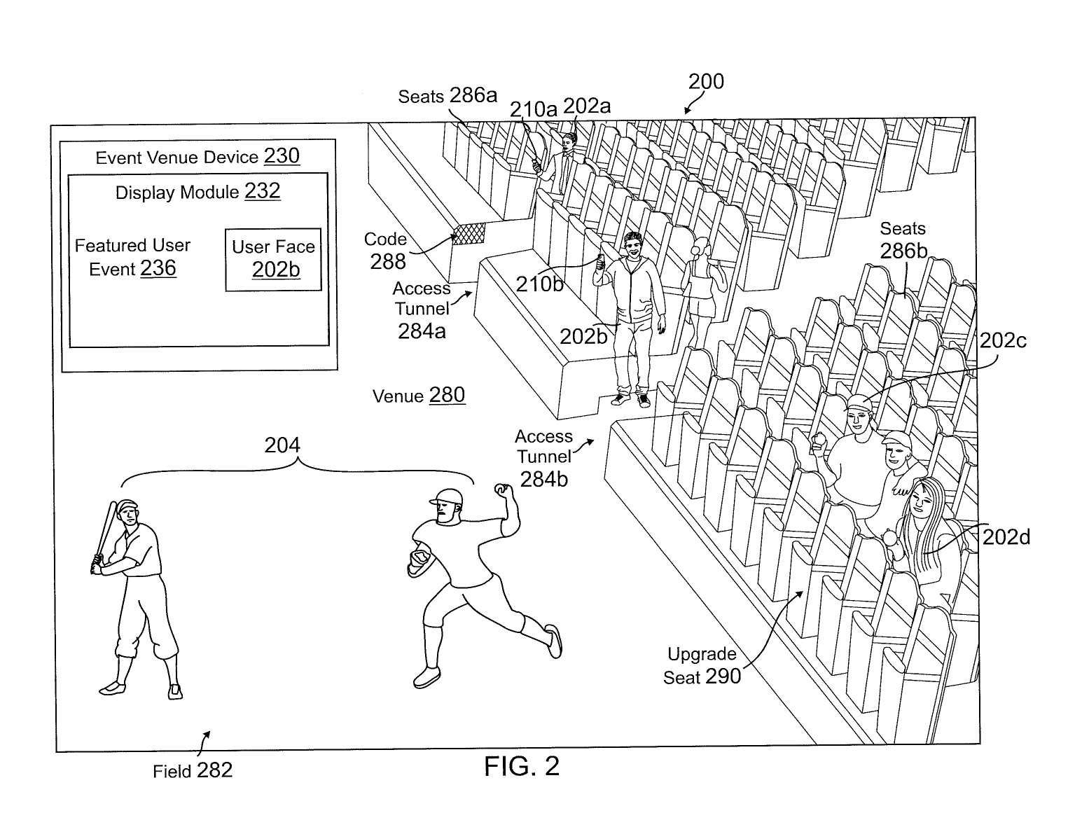

FIG. 2 is an exemplary event environment having displayable codes for upgrading a user's event admission ticket, according to an embodiment. An environment 200 of FIG. 2 includes a user 202a having a communication device 210a and a user 202b having a communication device 210b both corresponding generally to user 102 having communication device 110, respectively, of FIG. 1. Additionally, environment 200 includes an event venue device 230 corresponds generally to event venue device 130 of FIG. 1.

In environment 200, a venue 280 includes a field 282 where players 204 may be performing in a sporting event that users may view. In order to view players 204 on field 282, user 202a, user 202b, a user 202c, and a user 202d may sit in seats 286a and/or seats 286b. In order to arrive at seats 286a, an access tunnel 284a may be utilized. For example, user 202a may be seen walking through access tunnel 284a to seats 286a. Similarly, a user 202b may exit an access tunnel 284b on the way to seats 286b. Further users 202c and 202d are shown seated in seats 276b.

A venue 280, a code 288 is shown on a display in access tunnel 284a and nearby seats 286a and/or seats 276b. User 202a may view code 288 while user 202a is travelling to seats 286a, which may include a seat for user 202a in an event admission ticket held by user 202a. User 202a may utilize communication device 210a to scan/image code 288 and receive an upgrade to user 202a's event admission ticket for seats 286a. For example, the upgrade may include a sale of an event admission ticket in seats 286b that are located in closed proximity to field 282. User 202a may also view that users 202c and 202d are located in seats 286b through a social networking service and may be provided with benefits for either the purchase of the event admission ticket in the upgrade and/or for connecting with users 202c and/or 202d through the social networking service.

User 202b is shown walking to seats 286b through access tunnel 274b. User 202b may have already scanned/imaged code 288 and/or another code displayed at venue 28Q in order to purchase an upgraded event admission ticket for an available seat in seats 286b. For example, user 202b may have purchased upgrade seat 290 when user 202b scanned code 288 or another code at venue 280. As user approaches upgrade seat 290, event venue device 230 may execute a display module 232 corresponding generally to the specialized hardware and/or software modules and processes described in reference to display module 132 of FIG. 1. Display module 232 includes a display screen that may display a featured user event 236 for user 202b. Featured user event 236 includes media of user 202b that may be presented during the event on field 282 with players 204. For example, featured user event 236 includes user 202b's face or other media captured of user 202b. The media may include media captured by a device at venue 280, such as a video camera capturing a video of user 202b approaching upgrade seat 290.

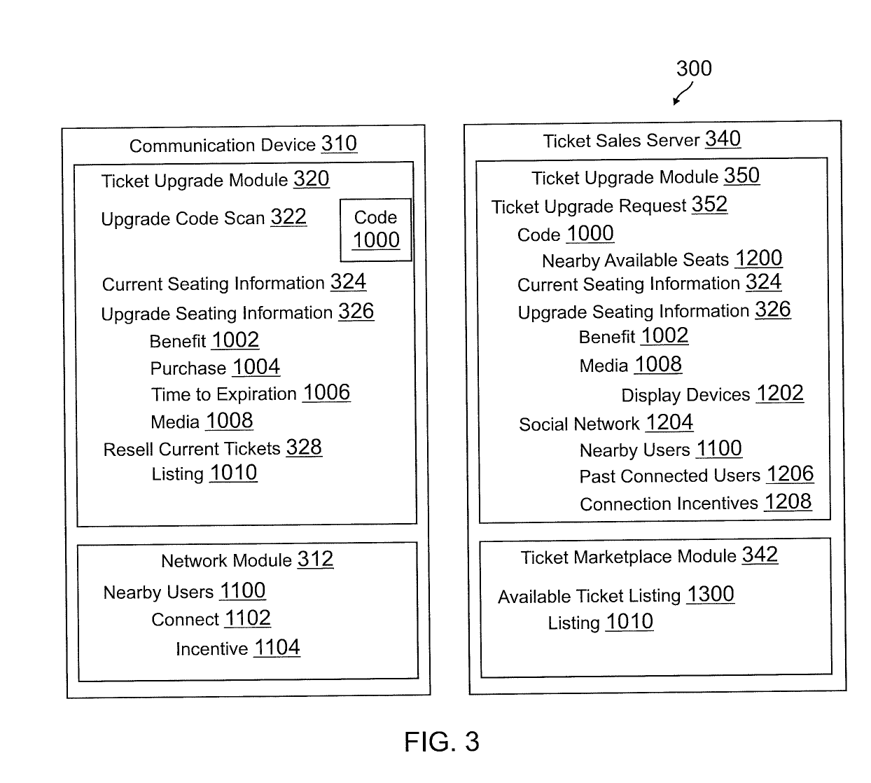

FIG. 3 is an exemplary system environment having a communication device receiving an upgrade to an event admission ticket based on a scan of a code displayed at the event's venue, according to an embodiment. Environment 300 of FIG. 3 includes a communication device 310 and a ticket sales server 340 corresponding generally to communication device 110 and ticket sales server 140, respectively, of FIG. 1.

Communication device 310 executes a ticket upgrade module 320 and a networking module 312 corresponding generally to the specialized hardware and/or software modules and processes described in reference to ticket upgrade module 120 and networking module 112, respectively, of FIG. 1. In this regard, ticket upgrade module 320 may be utilized to request a ticket upgrade for a first event admission ticket and receive an upgrade having a second event admission ticket. Ticket upgrade module 320 includes an upgrade code scan 322 of a code presented at a venue and user for a ticket upgrade request, such as code 1000. Ticket upgrade module 320 further includes current seating information 324 for a first event admission ticket, such as first seating information for a first seat at the venue for the event. Using at least code 1000 (as well as current seating information 324 in certain embodiments) a ticket upgrade request may be communicated to ticket sales server 340.

Thus, ticket upgrade module 320 may receive upgrade seating information 326 having information for a second event admission ticket having second seating information for a second seat at the venue (e.g., an upgraded seat in a more preferable location). With upgrade seating information 326, ticket upgrade module 320 may receive a benefit 1002 to incentive the user (not shown) of communication device 310 to purchase the second event admission ticket, a purchase 1004 option, a time to expiration 1006 notice of an expiration time of the upgrade, and media 1008 of the user for presentation if the user purchases the second event admission ticket. Ticket upgrade module 320 may further include a resell current tickets 328 option, which may include a listing 1010 for the user's first event admission ticket. For example, listing 1010 may include a resale offer for the first event admission ticket. However, where user 102 may pay the difference between the first event admission ticket and the second event admission ticket, resell current tickets 328 may not be displayed.

Communication device 310 further executes a networking module 312 that may be utilized with upgrade seating information 326. Networking module 312 may allow the user of communication device 310 to view and connect with nearby users, including users that have also upgraded their event admission tickets. Thus, networking module 312 includes nearby users 1100 with a connect 1102 option that may add one or more of nearby users 1100 to the users social network. Additionally, the user may accrue incentive 1104 when utilizing connect 1102 with nearby users 1100.

Ticket sales server 340 executes a ticker upgrade module 350 and a ticket marketplace module 342 corresponding generally to the specialized hardware and/or software modules and processes described in reference to ticket upgrade module 150 and ticket marketplace module 142, respectively, of FIG. 1. In this regard, ticket upgrade module 350 may receive a ticket upgrade request 352 from communication device 310. Ticket upgrade request 352 may include code 1000 received from communication device 310 after a scan/image by the user of communication device 310. With code 1000, ticket upgrade module 350 may access nearby available seats 1200. However, in other embodiments, ticket upgrade module 350 may access all available seats at the venue for the event from available event admission ticket information. Ticket upgrade module 350 may also access or receive current seating information 324 for the user of communication device 324, such as from a database or in the ticket upgrade request received from communication device 310.

Using nearby available seats 1200 and current seating information 324, ticket upgrade module 350 may determine upgrade seating information 326 with benefit 1002 and media 1008. Ticket upgrade module 350 may also determine display devices 1202 for use with media 1008 if the user wishes to purchase a second event admission ticket in upgrade seating information 326. Ticket upgrade module 350 may communicate media 1008 to display device 1202 in the event for the purchase. Further ticket upgrade module 350 may further utilize social network 1204 with upgrade seating information 326 to provide nearby users 1100 to networking module 312. Social network 1204 may also include past connected users 1206 for the user of communication device 310, which may also be displayed in networking module 312, for example, where one or more of past connected users 1205 are at the event with the user. Ticket upgrade module 350 may also provide one or more of connection incentives 1208 to networking module 312 for use when connecting with one or more of nearby users 1100.

As discussed herein, the user of communication device 310 may wish to utilize resell current tickets 328 option of ticket upgrade module 320. In other embodiments where ticket sales server 340 take ownership of the first event admission ticket associated with current seating information 324, ticket sales server 340 may wish to resell the first event admission ticket. Thus, ticket marketplace module 342 may be utilized to resell the first event admission ticket. Ticket marketplace module 342 includes available ticket listings 1300. Available ticket listings may include a listing for the first event admission ticket, such as listing 1010. In various embodiments, available ticket listings 1300 may also be utilized to determining upgrade seating information 326 in certain embodiments, for example, by providing available event admission ticket information.

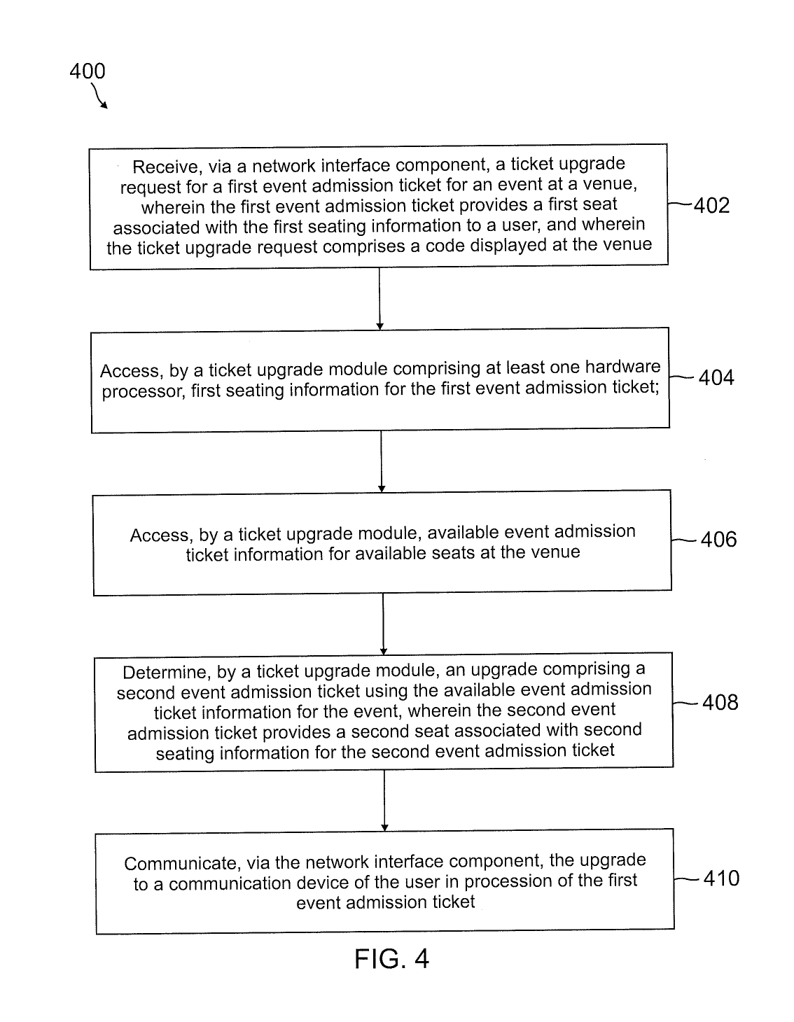

FIG. 4 is a flowchart of an exemplary process for event admission ticket upgrades through displayable codes at an event venue, according to an embodiment. Note that one or more steps, processes, and methods described herein may be omitted, performed in a different sequence, or combined as desired or appropriate.

At step 402, a ticket upgrade request for a first event admission ticket for an event at a venue is receive, via a network interface component, wherein the first event admission ticket provides a first seat associated with the first seating information to a user, and wherein the ticket upgrade request comprises a code captured by a communication device of the user, wherein the code is displayed at the venue. The code may comprise one of an alphanumeric code, a bar code, and a QR code. The code may be displayed in proximity to at least one of the first seat and a second seat (e.g., a second seat for a second event admission ticket, as discussed herein). First seating information for the first event admission ticket is accessed, by a ticket upgrade module comprising at least one hardware processor, at step 404. In various embodiments, the ticket upgrade request may further comprise at least one of information for the first event admission ticket and the first seating information.

At step 406, available event admission ticket information for available seats at the venue is accessed, by the ticket upgrade module. The available event admission ticket information may comprise available seats in proximity to a display sign displaying the code at the venue. The display sign may comprise a notice to scan the code to receive the upgrade. An upgrade comprising a second event admission ticket is determined, by the ticket upgrade module, using the available event admission ticket information for the event, wherein the second event admission ticket provides a second seat associated with second seating information for the second event admission ticket, at step 408. The upgrade may further comprise a benefit for use at the venue. For example, the benefit may comprise at least one of a discount to the second event admission ticket, a free food item at the venue, a free merchandise item at the venue, and a free media item associated with the user or the venue.

At step 410, the upgrade is communicated, via the network interface component, to a communication device of the user in possession of the first event admission ticket. The network interface component may receive a purchase request for the second event admission ticket, wherein the ticket upgrade module may process the purchase request to sell the second event admission ticket to the user. Thus, the network interface component may communicate at least the second seating information for the second event admission ticket to the communication device after the purchase by the user. The purchase request may comprise a payment for a price difference between the first event admission ticket and the second event admission ticket. A ticket marketplace module may determine a resale listing for the first event admission ticket and list the resale listing on a ticket marketplace for a resale purchase. The ticket marketplace module may further update the available event admission ticket information with at least one of the first event admission ticket and the first seating information.

In various embodiments, the ticket upgrade module may further access media of the user, wherein the network interface component communicates the media to a venue display device at the venue for display during the event. In other embodiments, a media capture device at the venue may record media of the user at the event and output the media for display using a venue display device at the venue. The media may comprise an image or a video of the user approaching the second seat. Additionally, at least one nearby user seated in proximity to the second seat may be determined and contact information for the at least one nearby user may be communicated to the communication device. Thus, a social networking service between the user and the at least one nearby user may be provided, as well as an incentive to the user to connect with the at least one nearby user using the social networking service.

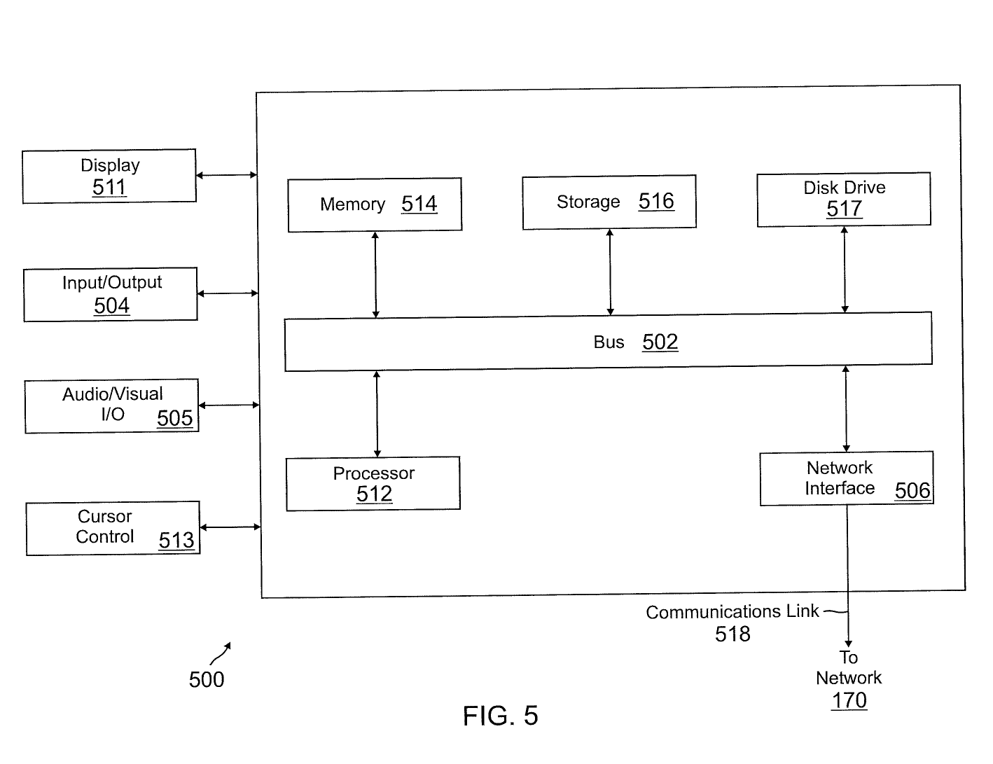

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 170. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media; and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a ticket upgrade module comprising at least one hardware processor that accesses a ticket upgrade request for a first event admission ticket for an event at a venue, accesses first seating information for the first event admission ticket, accesses available event admission ticket information, and determines an upgrade comprising a second event admission ticket using the available event admission ticket information for the event, wherein the first event admission ticket provides a first seat associated with the first seating information to a user, wherein the second event admission ticket provides a second seat associated with second seating information for the second event admission ticket, and wherein the ticket upgrade request comprises a code captured by a communication device of the user, wherein the code is displayed at the venue;
a database, stored to a non-transitory memory, that comprises the first seating information for the first event admission ticket, the available event admission ticket information, and the upgrade; and
a network interface component that receives the ticket upgrade request from the communication device of the user in possession of the first event admission ticket and communicates the upgrade to the communication device.

2. The system of claim 1, wherein the upgrade further comprises a benefit for use at the venue.

3. The system of claim 2, wherein the benefit comprises at least one of a discount to the second event admission ticket, a free food item at the venue, a free merchandise item at the venue, and a free media item associated with the user or the venue.

4. The system of claims 1, wherein the code comprises one of an alphanumeric code, a bar code, and a QR code.

5. The system of claim 1, wherein the network interface component receives a purchase request for the second event admission ticket and communicates at least the second seating information for the second event admission ticket to the communication device, and wherein the ticket upgrade module processes the purchase request to sell the second event admission ticket to the user.

6. The system of claim 5, wherein the purchase request comprises a payment for a price difference between the first event admission ticket and the second event admission ticket.

7. The system of claim 5 further comprising:
a ticket marketplace module that determines a resale listing for the first event admission ticket and lists the resale listing on a ticket marketplace for a resale purchase.

8. The system of claim 7, wherein the ticket marketplace module further updates the available event admission ticket information with at least one of the first event admission ticket and the first seating information.

9. The system of claim 5, wherein the ticket upgrade module further accesses media of the user, and wherein the network interface component communicates the media to a venue display device at the venue for display during the event.

10. The system of claim 5, wherein a media capture device at the venue records media of the user at the event and outputs the media for display using a venue display device at the venue.

11. The system of claim 10, wherein the media comprises an image or a video of the user approaching the second seat.

12. The system of claim 1, wherein the code is displayed in proximity to at least one of the first seat and the second seat.

13. The system of claim 1, wherein the available event admission ticket information comprises available seats in proximity to a display sign displaying the code at the venue.

14. The system of claim 13, wherein the display sign comprises a notice to scan the code to receive the upgrade.

15. A method comprising:
receiving, via a network interface component, a ticket upgrade request for a first event admission ticket for an event at a venue, wherein the first event admission ticket provides a first seat associated with the first seating information to a user, and wherein the ticket upgrade request comprises a code captured by a communication device of the user, wherein the code is displayed at the venue;
accessing, by a ticket upgrade module comprising at least one hardware processor, first seating information for the first event admission ticket;
accessing, by the ticket upgrade module, available event admission ticket information for available seats at the venue;
determining, by the ticket upgrade module, an upgrade comprising a second event admission ticket using the available event admission ticket information for the event, wherein the second event admission ticket provides a second seat associated with second seating information for the second event admission ticket; and
communicating, via the network interface component, the upgrade to the communication device of the user in possession of the first event admission ticket.

16. The method of claim 15, wherein the ticket upgrade request further comprises at least one of information for the first event admission ticket and the first seating information.

17. The method of claim 15, further comprising:
determining at least one nearby user seated in proximity to the second seat; and
communicating, via the network interface component, contact information for the at least one nearby user to the communication device.

18. The method of claim 17 further comprising:
providing a social networking service between the user and the at least one nearby user.

19. The method of claim 18 further comprising:
providing an incentive to the user to connect with the at least one nearby user using the social networking service.

20. A non-transitory computer readable medium comprising a plurality of machine-executable modules which when executed by at least one processor of a server are adapted to cause the server to perform a method comprising:
receiving, via a network interface component, a ticket upgrade request for a first event admission ticket for an event at a venue, wherein the first event admission ticket provides a first seat associated with the first seating information to a user, and wherein the ticket upgrade request comprises a code captured by a communication device of the user, wherein the code is displayed at the venue;
accessing, by a ticket upgrade module comprising at least one hardware processor, first seating information for the first event admission ticket;
accessing, by the ticket upgrade module, available event admission ticket information for available seats at the venue;
determining, by the ticket upgrade module, an upgrade comprising a second event admission ticket using the available event admission ticket information for the event, wherein the second event admission ticket provides a second seat associated with second seating information for the second event admission ticket; and
communicating, via the network interface component, the upgrade to the communication device of the user in possession of the first event admission ticket.
